(19) United States
(12) Patent Application Publication
(10) Pub. No.: US 2025/0068971 A1
(43) Pub. Date: Feb. 27, 2025

(54) MACHINE LEARNING SYSTEM AND MACHINE LEARNING METHOD

(71) Applicant: Hitachi, Ltd., Chiyoda-ku, Tokyo (JP)

(72) Inventors: Yosuke KAGA, Tokyo (JP); Kenta TAKAHASHI, Tokyo (JP); Wataru NAKAMURA, Tokyo (JP); Yusei SUZUKI, Tokyo (JP)

(21) Appl. No.: 18/723,555

(22) PCT Filed: Aug. 12, 2022
(86) PCT No.: PCT/JP2022/030793

§ 371 Date: Jun. 24, 2024

(30) Foreign Application Priority Data
Jan. 20, 2022 (JP) 2022-006933

(51) Int. Cl. G06N 20/00; H04L 9/40

(52) U.S. Cl. CPC G06N 20/00; H04L 63/08

(57) ABSTRACT

A machine learning system includes: a server holding a common model; and a plurality of clients each holding concealment target data and an individual model, the server transmits the common model to the plurality of clients, each of the plurality of clients: generates a learning result obtained by updating the common model based on the concealment target data and the individual model held by itself; and transmits the generated learning result to the server, and the server updates the common model based on the received learning result.

### CLAIM OF PRIORITY

The present application claims priority from Japanese patent application JP 2022-6933 filed on Jan. 20, 2022, the content of which is hereby incorporated by reference into this application.

### BACKGROUND OF THE INVENTION

This invention relates to a machine learning system and a machine learning method.

Personal authentication is processing of verifying that a user is a legitimate person registered in advance, and is executed in various information technology (IT) systems. Biometric authentication, which is a type of the personal authentication and confirms identity based on a physical or behavioral feature of a person, does not require a user to memorize a password or to carry a portable article such as an integrated circuit (IC) card, hence is highly convenient, and is attracting attention as reliable identity verification means.

As the feature used in the biometric authentication, the fingerprint, the face, the iris, and the vein of the user are known. In the biometric authentication, a feature amount is extracted from those physical or behavioral features, and the extracted feature amount is compared with a feature amount at the time of registration, to thereby determine the identity. As the feature amount, an image feature amount designed by an expert has often been used, but in recent years, feature extraction that uses machine learning represented by deep learning has generally been executed.

In the personal authentication based on the machine learning, a feature amount high in identification capability is learned based on training data, and hence an enormous amount of training data is required in order to attain highly accurate authentication. However, in recent years, laws and regulations relating to privacy of personal data, such as General Data Protection Regulation (GDPR), have become restrict, and hence, for collection of the personal data, acquisition of explicit consent, reliable data management, and the like are required. Thus, it has become difficult to collect, as the training data, an enormous amount of biometric information such as the fingerprint, the face, the iris, and the vein.

As one of technologies for solving this problem, a technology called “federated learning” has been proposed. The federated learning is a technology which does not collect the personal data and aggregates only weights of models each of which has been trained through use of the personal data, to thereby execute the learning. Thus, it is possible to train a machine learning model while privacy of the personal data is protected. In personal authentication to which this federated learning is applied, it is expected to train a highly accurate model without collecting an enormous amount of personal data.

However, as a disadvantage of the federated learning, it has been known that the accuracy decreases when data is imbalanced in each client. In the personal authentication, a certain individual basically occupies a client, and hence it is assumed that the personal data collected by the client is linked to the one certain individual. The situation in which only data in one class is included in a certain client as described above is a situation in which the imbalance of the data is the most significant. Thus, comparison with other classes cannot be made in the learning by the client, which causes a great decrease in accuracy. Accordingly, it is difficult to directly apply the federated learning proposed for the general classification problem to the personal authentication.

A technology as described in Non-Patent Document 1, a highly-accurate model is trained under such an assumption that only personal data on one person is stored in one client. In the technology as described in Non-Patent Document 1, a representative vector linked to the individual is defined in each client, and each client executes learning such that a feature vector extracted from the personal data through machine learning approaches the representative vector.

Moreover, a technology as described in Non-Patent Document 2 executes learning which protects the privacy under such an assumption that the personal data on only one person is stored in one client as in the technology as described in Non-Patent Document 1.

Non-Patent Document 1: “Federated Learning with Only Positive Labels. Proceedings of the 37th International Conference on Machine Learning, in Proceedings of Machine Learning Research 119:10946-10956,” Yu, F., Rawat, A. S., Menon, A., Kumar, S., 2020, [retrieved on Jan. 4, 2022], Internet <https://proceedings.mlr.press/v119/yu20f.html>

Non-Patent Document 2: “Federated Learning of User Verification Models Without Sharing Embeddings. Proceedings of the 38th International Conference on Machine Learning, in Proceedings of Machine Learning Research 139:4328-4336,” Hosseini, H., Park, H., Yun, S., Louizos, C., Soriaga, J., Welling, M., 2021, [retrieved on Jan. 4, 2022], Internet <https://proceedings.mlr.press/v139/hosseini21a.html>

In the technology as described in Non-Patent Document 1, a plurality of clients transmit the representative vectors to a server, and the server executes learning such that a distance between the representative vectors is sufficiently long. When the server does not execute the learning of the representative vectors, the distance between the feature vectors in different classes is not long. Thus, the feature vectors corresponding to all classes converge to the same vector, and hence a model which cannot identify the classes is trained. Meanwhile, in the technology as described in Non-Patent Document 1, the server executes the learning of the representative vectors, and the distance between the feature vectors in different classes thus becomes long. As a result, a highly accurate model which can identify the classes can be trained.

That is, in the technology as described in Non-Patent Document 1, it is required to share the representative vector in each class between the client and the server. The representative vector is a representative value of the feature vectors used at the time of the authentication, and hence a third party which has acquired the representative vector can impersonate the individual associated with the representative vector.

Further, a third party which has acquired the representative vector and the trained model can infer original personal data through a method called “model inversion attack.” Thus, in this method of sharing the representative vector with the server as in the technology as described in Non-Patent Document 1, there is such a risk that the impersonation or leakage of the personal data may occur as a result of the eavesdropping of communication or cyber-attack against the server, and hence it is considered that privacy protection is not sufficient.

Meanwhile, in the technology as described in Non-Patent Document 2, each client randomly allocates a representative vector separated by a certain distance, and executes learning such that a feature vector extracted from the personal data through machine learning approaches the representative vector. In the technology as described in Non-Patent Document 2, the client manages the representative vector and hence the representative vector is not transmitted to a server. Thus, in the technology as described in Non-Patent Document 2, privacy relating to the representative vector is protected, that is, the risk of the impersonation of the individual or the personal data leakage can be avoided.

However, with the technology as described in Non-Patent Document 2, the representative vector is randomly allocated, and hence similarity between classes is not considered. For example, individuals who are very similar to each other should have feature vectors close to each other and individuals who are not similar to each other at all should have feature vectors apart from each other. However, in the technology as described in Non-Patent Document 2, this similarity is not considered, and there is a fear that a situation in which the representative vectors of the individuals similar to each other are greatly apart from each other may occur. When the representative vectors which do not reflect the similarity between the classes are used as in the technology as described in Non-Patent Document 2, the accuracy of the model obtained through the learning does not sufficiently increase.

In other words, it is possible to obtain a highly accurate trained model (example of a common model) while reducing the risk of the impersonation and the personal data leakage by executing the learning by allocating the representative vector reflecting the similarity between the classes while protecting the privacy of the representative vector (example of an individual model).

Thus, at least one aspect of this invention acquires a highly accurate common model while protecting concealment target data and an individual model.

In order to solve the above problems, the present invention adopts the following structures in order to solve the above problem. A machine learning system, comprises: a server configured to hold a common model; and a plurality of clients each configured to hold concealment target data and an individual model, wherein the server is configured to transmit the common model to the plurality of clients, wherein each of the plurality of clients is configured to: generate a learning result obtained by updating the common model based on the concealment target data and the individual model held by the each of the plurality of clients itself; and transmit the generated learning result to the server, and wherein the server is configured to update the common model held by the server itself based on the learning result received from the each of the plurality of clients.

The at least one aspect of the present invention can acquire the highly accurate common model while protecting the concealment target data and the individual model.

Problems, configurations, and effects which are not mentioned above are explained in the following embodiments.

### BRIEF DESCRIPTIONS OF DRAWINGS

FIG. 1 is a block diagram for illustrating a configuration example of a machine learning system according to the first embodiment.

FIG. 2 is a block diagram for illustrating a hardware configuration example of a computer which implements each of a client, a learning server, and a parameter server according to the first embodiment.

FIG. 3 is a sequence diagram for illustrating an example of federated learning processing for personal authentication according to the first embodiment.

FIG. 4 is a flowchart for illustrating an example of personal data collection processing according to the first embodiment.

FIG. 5 is a flowchart for illustrating an example of local learning processing according to the first embodiment.

FIG. 6 is a flowchart for illustrating an example of model update processing according to the first embodiment.

FIG. 7 is a flowchart for illustrating an example of individual model storage processing according to the first embodiment.

FIG. 8 is a sequence diagram for illustrating an example of personal authentication processing that uses a common model according to the first embodiment.

FIG. 9 is a sequence diagram for illustrating an example of federated learning processing for personal authentication according to the second embodiment.

### DETAILED DESCRIPTION OF THE PREFERRED EMBODIMENTS

A detailed description is now given of embodiments of this invention with reference to the drawings. In the embodiments, the same reference symbol is principally assigned to the same component, and a redundant description thereof is omitted. It should be noted that the embodiments are merely examples for embodying this invention and do not limit the technical scope of this invention.

### First Embodiment

In a first embodiment of this invention, the following machine learning system is described. A client applies concealment transformation to a representative vector (example of an individual model) generated from personal data, and then shares the representative vector with a learning server. The learning server optimizes the representative vector, and then shares the representative vector with the client. The client applies inverse transformation of the concealment transformation to the representative vector, and then holds the representative vector.

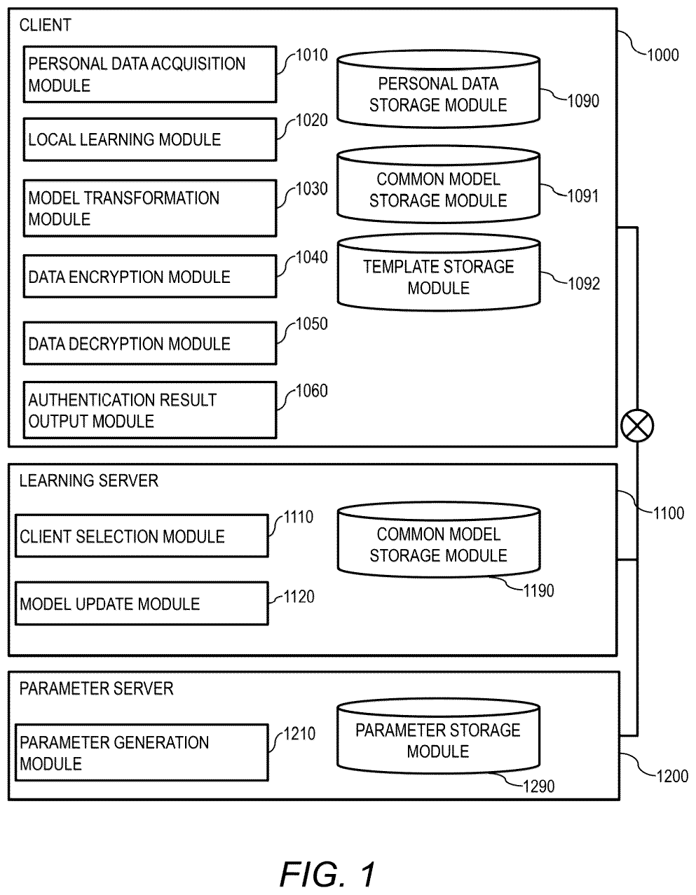

FIG. 1 is a block diagram for illustrating a configuration example of the machine learning system. The machine learning system includes, for example, a client 1000, a learning server 1100, and a parameter server 1200 coupled to each other via a network such as the Internet. The machine learning system includes the one client 1000 in the example of FIG. 1, but may include a plurality of clients 1000.

The client 1000 includes a personal data acquisition module 1010, a local learning module 1020, a model transformation module 1030, a data encryption module 1040, a data decryption module 1050, and an authentication result output module 1060, each of which is a functional module. Moreover, the client 1000 includes a personal data storage module 1090, a common model storage module 1091, and a template storage module 1092, each of which is a storage area for storing data.

The personal data acquisition module 1010 acquires, from an individual (for example, a user of the client 1000), data associated with the individual. The local learning module 1020 trains a common model and an individual model based on the personal data acquired by the personal data acquisition module 1010. The model transformation module 1030 applies concealment transformation to a representative vector generated from the personal data and the common model.

The data encryption module 1040 encrypts the personal data and the representative vector, to thereby prevent individual information leakage. The data decryption module 1050 decrypts the personal data and the representative data encrypted by the data encryption module 1040, to thereby extract original data. The authentication result output module 1060 outputs a result of personal authentication that uses the personal data.

The personal data storage module 1090 holds the personal data and the representative vector. The common model storage module 1091 holds the trained common model. The trained common model is used for the personal authentication. The template storage module 1092 holds a template used for personal authentication processing that uses the trained common model.

The learning server 1100 includes, for example, a client selection module 1110 and a model update module 1120, each of which is a functional module. Moreover, the learning server 1100 includes a common model storage module 1190, which is an area for storing data.

The client selection module 1110 selects the clients 1000 which participate in a learning round for this time from the clients 1000 which can participate in the learning. The model update module 1120 uses the personal data to update weights of the common model and the individual model. The model update module 1120 defines, for example, a loss function for the model, and minimizes this loss function, to thereby achieve the update of the weight. The common model storage module 1190 holds the trained common model.

The parameter server 1200 includes, for example, a parameter generation module 1210 which is a function module and a parameter storage module 1290 which is a storage area for storing data. The parameter server 1200 is a device independent of the client 1000 and the learning server 1100, and it is assumed that a risk of leakage of information therefrom is sufficiently low. However, when sufficient security can be ensured, the parameter server 1200 may exist in the same device such as a different virtual environment in the same physical server as that of the learning server 1100. Moreover, the client 1000 and the parameter server 1200 may be integrated with each other, that is, the client 1000 may generate and manage the parameter.

The parameter generation module 1210 generates the parameter used for the concealment transformation for the individual model. The concealment transformation is processing of encrypting the individual model, to thereby make it difficult for a third party which does not know the parameter to restore or infer the individual model. As a method of achieving the encryption for the individual model, for example, random projection, random padding, or the like is applied. In particular, when an orthonormal matrix is used as a transformation basis, it is possible to achieve a state in which a distance between the individual models before the concealment transformation and a distance between the individual models after the concealment transformation are equal to each other. The parameter storage module 1290 holds the parameter generated by the parameter generation module 1210.

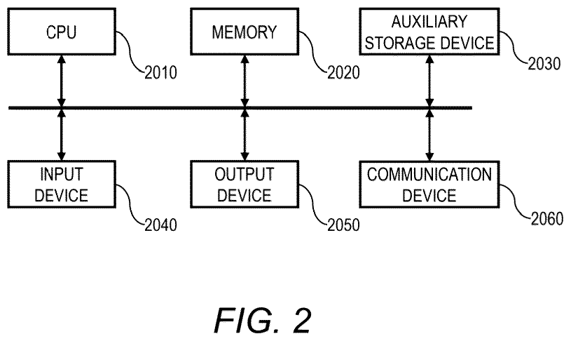

FIG. 2 is a block diagram for illustrating a hardware configuration example of a computer which implements each of the client 1000, the learning server 1100, and the parameter server 1200. The computer includes, for example, a central processing unit (CPU) 2010, a memory 2020, an auxiliary storage device 2030, an input device 2040, an output device 2050, and a communication device 2060 each of which is coupled via an internal communication line such as a bus.

The CPU 2010 includes a processor, and executes a program stored in the memory 2020. The memory 2020 includes a read only memory (ROM), which is a nonvolatile memory device, and a random access memory (RAM), which is a volatile memory device. The ROM stores, for example, an invariant program (for example, basic input/output system (BIOS)). The RAM is a dynamic random access memory (DRAM) or other such high-speed and volatile memory device, and temporarily stores a program to be executed by the CPU 2010 and data to be used when the program is executed by the CPU 2010.

The auxiliary storage device 2030 is, for example, a large-capacity and non-volatile storage device such as a magnetic storage device (hard disk drive (HDD)) and a flash memory (solid state drive (SSD)). Programs to be executed by the CPU 2010 and data to be used when the programs are executed by the CPU 2010 are stored in the auxiliary storage device 2030. Specifically, the programs are read out from the auxiliary storage device 2030, loaded onto the memory 2020, and executed by the CPU 2010.

The input device 2040 is a device, such as a keyboard, a touch panel, a smart device, or a mouse, which receives input from an operator. Moreover, the input device 2040 includes a device, such as a biometric sensor, a scanner, or a camera, which is used to acquire biometric information (an example of the personal data). The output device 2050 is a device, such as a display device or a printer, which outputs an execution result of a program in a form visually recognizable by the operator.

The communication device 2060 is a network interface device which controls communication to and from another device in accordance with a predetermined protocol. Further, the communication device 2060 may include, for example, a serial interface such as a universal serial bus (USB).

All or some of the programs executed by the CPU 2010 may be provided to the computer from a removable medium (such as a CD-ROM or a flash memory) being a non-transitory storage medium or from an external computer including a non-transitory storage device via a network, and may then be stored in the nonvolatile auxiliary storage device 2030 being a non-transitory storage medium. Thus, it is preferred that the computer include an interface which reads data from the removable medium.

Each of the client 1000, the learning server 1100, and the parameter server 1200 is a computer system formed on physically one computer or formed on a plurality of computers that are configured logically or physically, and may be operated on separate threads on the same computer, or may operate on a virtual machine built on a plurality of physical computer resources.

The CPU 2010 of the computer forming the client 1000 includes the personal data acquisition module 1010, the local learning module 1020, the model transformation module 1030, the data encryption module 1040, and the data decryption module 1050. The CPU 2010 of the computer forming the learning server 1100 includes the client selection module 1110 and the model update module 1120. The CPU 2010 of the computer forming the parameter server 1200 includes the parameter generation module 1210.

For example, the CPU 2010 of the computer forming the client 1000 operates in accordance with a personal data acquisition program loaded on the memory 2020 of this computer to function as the personal data acquisition module 1010, and operates in accordance with a local learning program loaded on the memory 2020 of this computer to function as the local learning module 1020.

For each of the other function modules included in the CPU 2010 of the computer forming the client 1000, a relationship between a program and the function module is also the same. Moreover, for each of the function modules included in the CPU 2010 of the computer forming the learning server 1100 and each of the function modules included in the CPU 2010 of the computer forming the parameter server 1200, a relationship between a program and the function module is also the same.

Moreover, the auxiliary storage device 2030 of the computer forming the client 1000 provides storage areas for implementing the personal data storage module 1090, the common model storage module 1091, and the template storage module 1092. The auxiliary storage device 2030 of the computer forming the learning server 1100 provides a storage area for implementing the common model storage module 1190. The auxiliary storage device 2030 of the computer forming the parameter server 1200 provides a storage area for implementing the parameter storage module 1290.

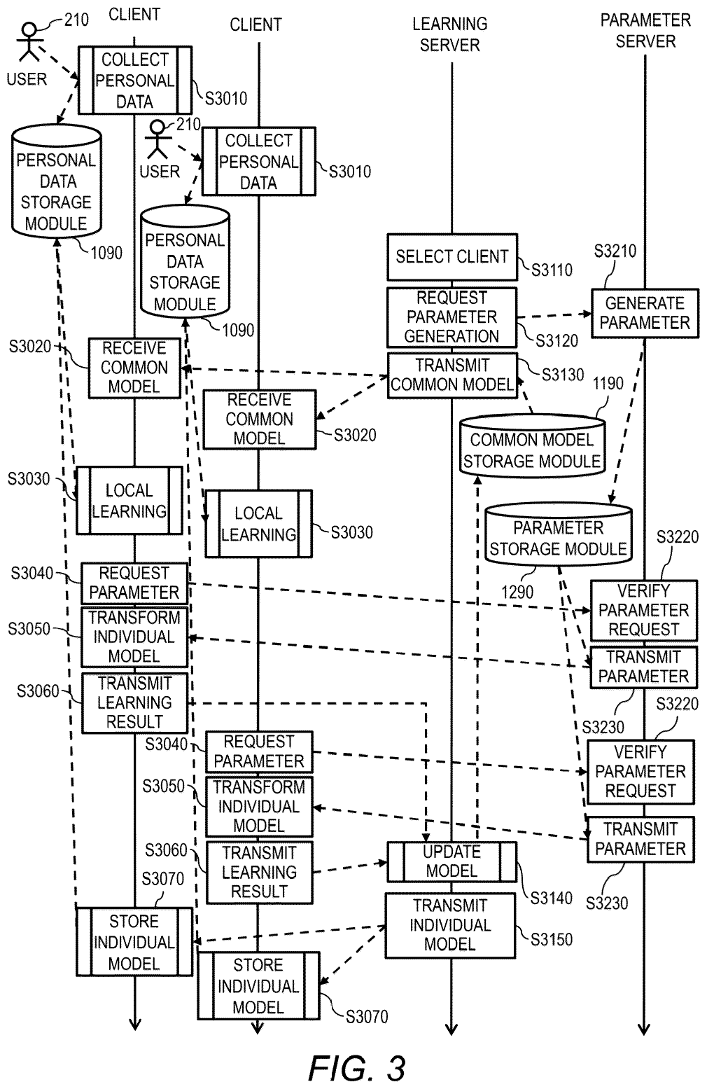

FIG. 3 is a sequence diagram for illustrating an example of federated learning processing for personal authentication. The three parties being the client 1000, the learning server 1100, and the parameter server 1200 execute the federated learning of a model used for the personal authentication. In the example of FIG. 3, a plurality of (two) clients 1000 are illustrated, but each client 1000 executes the same processing. Thus, the processing by the clients 1000 is described while avoiding redundancy.

The personal data acquisition module 1010 of the client 1000 acquires the personal data from a user 210 (for example, a user of this client 1000) (S3010). The personal data is data used for the personal authentication, and includes information indicating physical information, for example, the fingerprint, the face, the iris, and the vein and behavioral features such as acceleration information, a movement history, a browse history, and a purchase history of the individual. Any concealment target data may be used in place of the personal data.

The personal data acquisition processing of Step S3010 may be executed only for the purpose of the data collection or only for the purpose of the authentication, and the acquired personal data may then be accumulated. As a result of repetition of the processing step of Step S3010, the personal data on the user 210 is accumulated in the client 1000.

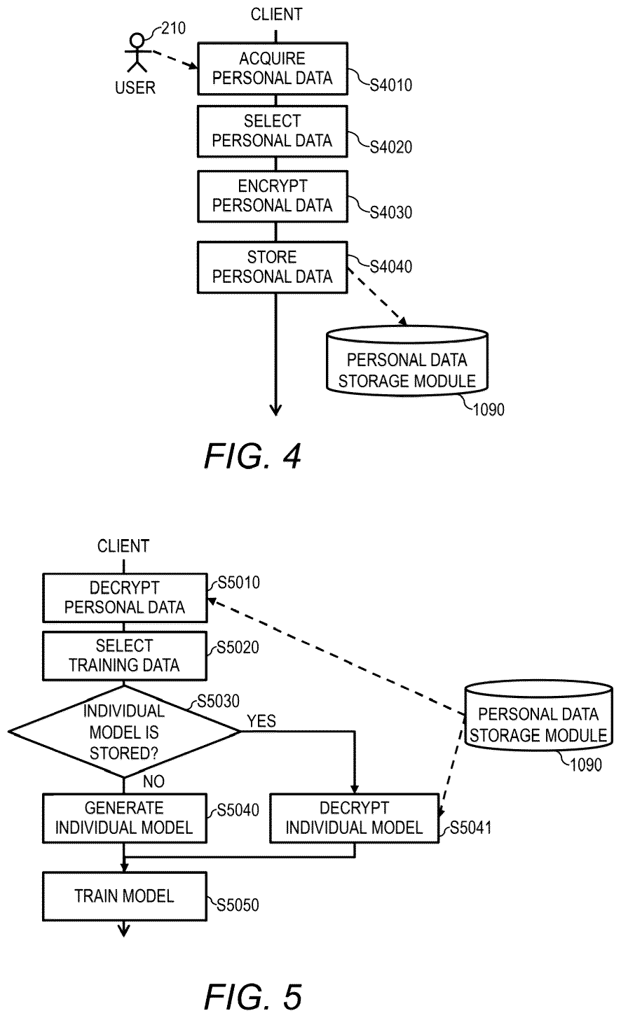

When one user 210 occupies the client 1000, the personal data on this specific user 210 is accumulated. Meanwhile, for example, the client 1000 shared by a plurality of users 210 may accumulate the personal data on the plurality of users or the personal data accumulated by another plurality of clients 1000 may be aggregated into one client 1000 for use in the federated learning. Details of Step S3010 are described later with reference to FIG. 4.

The client selection module 1110 of the learning server 1100 selects participating clients 1000 which participate in the learning in the round for this time (S3110). Specifically, for example, the client selection module 1110 selects the participating clients 1000 by a method of selecting all clients 1000, a method of asking the client 1000 whether or not this client 1000 can participate in the learning and selects the client 1000 which responds that this client 1000 can participate, a method of randomly selecting the client 1000 in accordance with a ratio determined in advance, a method of selecting the client 1000 in accordance with an upper limit determined in advance, a method of calculating an evaluation value (for example, an evaluation value having a higher value as the number of times of the collection of the personal data increases and the evaluation value having a higher value as a date and time of the last participation of the learning is older) of the client 1000, and selecting a predetermined number of clients 1000 having the highest or lowest calculated evaluation values, a method of executing weighting in accordance with the calculated evaluation value, and then randomly selecting a predetermined number of clients 1000, and the like.

The client selection in Step S3110 may be executed by the parameter server 1200 in place of the learning server 1100. In this case, the parameter server 1200 manages the clients 1000 which can participate, and selects the client by the above-mentioned selection method from the clients 1000 which can participate.

The model update module 1120 of the learning server 1100 makes a parameter generation request to the parameter server 1200 (S3120), and the parameter generation module 1210 of the parameter server 1200 generates the parameter (S3210).

The model update module 1120 of the learning server 1100 may include, in the parameter generation request, an IP address or a terminal number as an identifier for uniquely identifying each of the participating clients 1000 selected in Step S3110. It should be noted, however, that when the parameter server 1200 executes the client selection processing of Step S3110, the model update module 1120 of the learning server 1100 is not required to include the data for identifying the client 1000 in the parameter generation request.

In the federated learning, communication to and from the participating clients 1000 is executed to update the models in a certain period called “round,” and this parameter is used in common for all participating clients 1000 in the round for this time. This parameter is used in individual model transformation processing of Step S3050 described later, and is defined as, for example, a randomly generated vector or matrix.

The model update module 1120 of the learning server 1100 transmits the common model stored in the common model storage module 1190 to each participating client 1000 (S3130). The common model is a machine learning model which receives the personal data as input and outputs a feature vector, and is a general machine learning model, for example, a neural network.

For example, when image data on, for example, the fingerprint, the face, the iris, and the vein is used as the personal data, a deep learning model such as convolutional neural networks (CNN) or Transformer can be applied as the common model. The common model may be initialized in advance through use of a random weight at the time of a start of the learning, or may be optimized in advance through use of a weight trained in advance through use of personal data different from that stored in the client 1000.

The participating client 1000 receives the common model from the learning server 1100 (S3020), and the local learning module 1020 of the participating client 1000 executes local learning processing of using the personal data to update the common model and the individual model (S3030).

The common model is a machine learning model as described in Step S3130 while the individual model is a model which is not shared with the learning server 1100 in a non-encrypted form (shared in the encrypted form), which is different from the common model, and is a model which varies from one client 1000 to another client 1000.

For example, in the metric learning of extracting the feature vectors from the personal data and causing a distance between the feature vectors to reflect similarity between the personal data, the representative vector of the feature vectors can be used as the individual model. This representative vector is sensitive information associated with the user 210 of the client 1000. Thus, when a third party acquires this data, the risk of the impersonation and the personal data leakage occurs. Details of the local learning processing of Step S3030 are described later with reference to FIG. 5.

The model transformation module 1030 of the participating client 1000 makes a parameter request to the parameter server 1200 (S3040). In the example of FIG. 3, there is provided a system in which the parameter server 1200 delivers the parameter to the participating clients 1000, to thereby synchronize each participating client 1000 with one another, but the method for each participating client 1000 to acquire the parameter is not limited to this system.

For example, each participating client 1000 may apply conversion that uses a hash function or the like to data acquired by each participating client 1000 in common such as a date and time, to thereby generate the parameter. Moreover, each participating client 1000 may be allowed to manage a hardware token or the like storing secret information to generate the common parameter on the token. When each participating client 1000 executes the parameter generation independently of the parameter server 1200 as described above, the machine learning system is not required to include the parameter server 1200.

The parameter generation module 1210 of the parameter server 1200 verifies the parameter request from each participating client 1000 (S3220). The parameter is data corresponding to an encryption key used in individual model transformation processing of Step S3050 described later, and hence a third party which simultaneously acquires the data subjected to the concealment transformation and the parameter can execute decryption to the original data. Thus, it is desired that the parameter be shared by only legitimate participating clients 1000.

Thus, the parameter generation module 1210 determines, in the verification of the parameter request in Step S3220, whether or not the client 1000 which has transmitted the parameter request is the participating client 1000 in the round for this time and transmits the parameter to this participating client 1000 only when this participating client 1000 is determined to be the participating client 1000 in the round for this time (S3230).

When the parameter generation module 1210 determines that the parameter request is received from the client 1000 which is not the participating client 1000, the parameter generation module 1210 does not transmit the parameter to this client 1000 or transmits a parameter different from the correct parameter to this client 1000, to thereby conceal the parameter.

The model transformation module 1030 of the participating client 1000 applies the concealment transformation to the individual model based on the parameter received from the parameter server 1200, to thereby generate the concealed individual model (S3050).

The individual model is a model defined as a vector or a matrix and is associated with the individual. For example, when the metric learning for the feature vector for the personal data is executed, the representative vector of the feature vectors can be used as the individual model. The individual model includes information on the feature vectors for the personal data and hence the impersonation or the inference of the personal data can be achieved through use of the individual model. Thus, the participating client 1000 applies the concealment transformation to the individual model when the individual model is shared with the learning server 1100, the parameter server 1200, and the other clients 1000, to thereby bring about a state in which those devices cannot acquire the original individual model.

The model transformation module 1030 of the participating client 1000 transmits, as a learning result, the common model and the concealed individual model to the learning server 1100 (S3060).

When the learning result is directly transmitted from the participating client 1000 to the learning server 1100, the learning server 1100 can recognize the participating client 1000 which has transmitted the learning result. In this case, when certain individual information is leaked from the common model or the concealed individual model, the participating client 1000 being the source of the leak is identified. In order to prevent this situation, a shuffle server may be interposed between the participating client 1000 and the learning server 1100 when the learning result is transmitted from the participating client 1000 to the learning server 1100, to thereby execute order shuffle of or addition of another identifier to the learning result received by the shuffle server from the client 1000. With this configuration, the correspondence between the data received from the learning server 1100 and the client 1000 cannot be recognized, and hence higher security can be achieved.

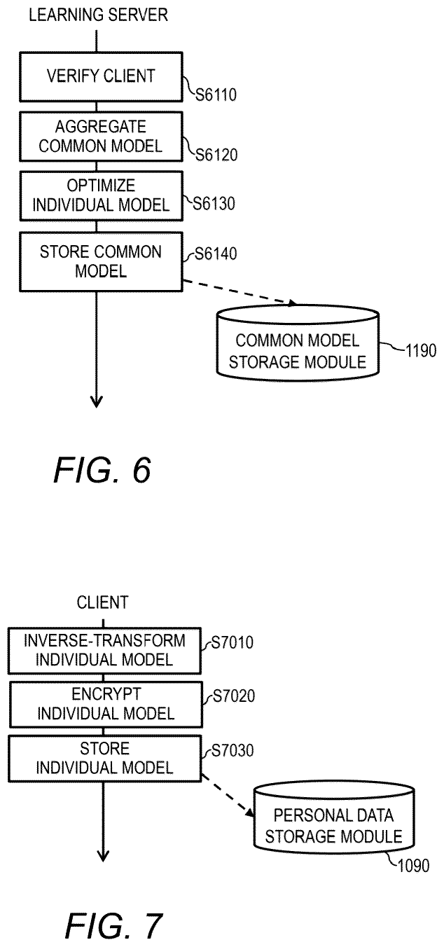

The learning server 1100 receives the common model and the concealed individual model from each of the plurality of participating clients 1000, and the model update module 1120 of the learning server 1100 executes model update processing including the aggregation of the common models and the optimization of the individual models (S3140). Details of the model update processing of Step S3140 are described later with reference to FIG. 6.

The model update module 1120 of the learning server 1100 transmits the concealed individual model updated in Step S3140 to each participating client (S3150). The concealed individual model exists for each participating client 1000, and hence the model update module 1120 transmits each concealed individual model to only the corresponding participating client 1000. When the model update module 1120 transmits the concealed individual model to another participating client 1000 by mistake, this participating client 1000 knows the parameter and hence can decrypt the individual model of the right participating client 1000. Thus, the risk of the impersonation and the personal data inference occurs.

The model transformation module 1030 of the participating client 1000 applies inverse transformation of the concealment transformation to the concealed individual model received from the learning server 1100, to thereby acquire the individual model, and stores the acquired individual model in the personal data storage module 1090 of this participating client 1000 (S3070). Details of the individual model storage processing of Step S3070 are described later with reference to FIG. 7.

With the processing described above, while the privacy of the personal data and the individual model in the client 1000 are protected, the federated learning of the common model can be executed in the learning server 1100.

FIG. 4 is a flowchart for illustrating an example of the personal data collection processing of Step S3010. The personal data acquisition module 1010 of the client 1000 acquires the personal data from the user 210 (S4010). As described in Step S3010, the personal data includes the information indicating the physical information, for example, the fingerprint, the face, the iris, and the vein of the user 210 and the behavioral features such as the acceleration information, the movement history, the browse history, and the purchase history of the user 210.

The personal data acquisition module 1010 selects the personal data used for the federated learning from the personal data acquired in Step S4010 (S4020). The personal data selection processing of Step S4020 may be omitted, and the entire personal data acquired in Step S4010 by the personal data acquisition module 1010 may be used for the learning. However, the personal data acquisition module 1010 can reduce the personal data by executing the data selection processing of Step S4020, and can consequently reduce a calculation amount for the learning and a storage capacity of the personal data storage module 1090.

Moreover, an accuracy of the finally obtained common model can be increased by the personal data acquisition module 1010 excluding, in the personal data selection processing of Step S4020, personal data less contributing to the learning and personal data adversely affecting the learning.

The personal data acquisition module 1010 specifically calculates an evaluation value for, for example, each piece of personal data in the personal data selection processing of Step S4020 and selects personal data having this evaluation value equal to or higher than a predetermined threshold value, personal data having this evaluation value lower than a predetermined threshold value, a predetermined number of pieces of personal data highest in this evaluation value, a predetermined number of pieces of personal data lowest in this evaluation value, and personal data having this evaluation value within a predetermined range.

The personal data acquisition module 1010 may not calculate the evaluation value for each piece of personal data, but may select the personal data by repeating calculation of an evaluation value for distances between pieces of acquired personal data or an evaluation value for a set of the acquired pieces of personal data and exclusion of the personal data based on this evaluation value.

When, for example, a face image is used as the personal data, the face images appearing in a moving image are very similar between frames. Thus, even when a large number of similar face images are learned, efficiency is low and the accuracy is unlikely to increase. Moreover, face images of the face turning sideways, the face blocked by the hands, and the face exceeding an image pickup range have large errors, and hence are inappropriate as the training data.

The personal data acquisition module 1010 excludes the above-mentioned personal data. Thus, when, for example, feature extraction is executed for each face image to generate a feature vector, and a distance between those feature vectors is sufficiently short, that is, the face images are sufficiently similar to each other, one of the face images is excluded from the training data, to thereby be able to exclude similar personal data. Moreover, the personal data acquisition module 1010 calculates a quality value including the direction of the face, absence/presence of the blocking, absence/presence of the exceeding, and the like from the face image, and excludes face images each having a quality value equal to or higher than a predetermined value or excludes face images each having a quality value lower than a predetermined value, to thereby be able to exclude inappropriate personal data.

After that, the data encryption module 1040 of the client 1000 encrypts the personal data selected in Step S4020 (S4030). The personal data encryption processing of Step S4030 is executed in order to prevent the personal data leakage caused by an unauthorized access to the client 1000 by a third party or malware infection of the client 1000.

For example, when the client 1000 is reliable or safety of the client 1000 is guaranteed by means other than the encryption of the data, the personal data acquisition module 1010 may skip the personal data encryption processing of Step S4030.

In order to encrypt the personal data, a secret key is typically required. This secret key is stored in a safe area of the client 1000, such as the auxiliary storage device 2030 in the client 1000 or a trusted execution environment (TEE), or an external medium such as a hardware token.

The data encryption module 1040 may use a biometric encryption technology such as a Fuzzy Extractor to dynamically generate a secret key from the personal data such as the biometric information. In this case, the data encryption module 1040 can dynamically generate the secret key from the personal data of the learning target to execute the personal data encryption processing, and hence it is not required to prepare the secret key for the encryption in advance.

After that, the data encryption module 1040 stores the personal data encrypted in Step S4030 in the personal data storage module 1090 (S4040). As a result of the above-mentioned processing, the client 1000 can acquire the personal data from the user 210, encrypt the acquired personal data into a secure form, and then store the personal data in the personal data storage module 1090.

FIG. 5 is a flowchart for illustrating an example of the local learning processing of Step S3030. The data decryption module 1050 of the participating client 1000 decrypts the personal data stored in the personal data storage module 1090 (S5010). The secret key used at the time of the encryption of the personal data is required for the decryption of the personal data. The data decryption module 1050 acquires or generates this secret key by the same procedure as that of Step S4030.

After that, the local learning module 1020 of the participating client 1000 selects the training data to be used for the local learning from the personal data decrypted in Step S5010 (S5020). Specifically, for example, the local learning module 1020 randomly selects a predetermined number of pieces of personal data from the decrypted personal data.

The local learning module 1020 may calculate an evaluation value for each piece of personal data and select, as training data, personal data having this evaluation value equal to or higher than a predetermined threshold value, personal data having this evaluation value lower than a predetermined threshold value, a predetermined number of pieces of personal data highest in this evaluation value, a predetermined number of pieces of personal data lowest in this evaluation value, and personal data having this evaluation value within a predetermined range.

The local learning module 1020 may not calculate the evaluation value for each piece of personal data, but may select the personal data as training data by repeating calculation of an evaluation value for distances between pieces of acquired personal data or an evaluation value for a set of the acquired pieces of personal data and exclusion of the personal data based on this evaluation value.

Further, from a viewpoint of the learning, when the distance between the feature vector and the representative vector calculated from the personal data is too short, contribution to the learning is small, and hence effectiveness is low. When the distance is too long, it is difficult to reduce the distance by the learning. Thus, the local learning module 1020 calculates the distance between the feature vector and the representative vector, and retains only the personal data having this distance within a predetermined range as the training data, to thereby be able to execute efficient and highly accurate learning.

After that, the local learning module 1020 determines whether or not the individual model is stored in the personal data storage module 1090 (S5030). When the local learning module 1020 determines that the individual model is stored in the personal data storage module 1090 (“YES” in S5030), the data decryption module 1050 reads out the encrypted individual model from the personal data storage module 1090, and decrypts the read encrypted individual model (S5041).

When the local learning module 1020 determines that the individual model is not stored in the personal data storage module 1090 (“NO” in S5030), the local learning module 1020 generates the individual model (S5040). Specifically, for example, the local learning module 1020 inputs the personal data to the common model to generate the feature vectors, and applies predetermined statistical calculation such as obtaining an average value or a median of the obtained feature vectors, to thereby generate the individual model. The local learning module 1020 may hold a pre-trained model at the time of start of the federated learning as the common model, and may use this held common model to generate the individual model. As another example, the local learning module 1020 may use the newest common model received by the participating client 1000 in Step S3020 to generate the individual model. The local learning module 1020 may generate the individual model by not using the personal data, but using a random weight to initialize the individual model.

The local learning module 1020 uses the training data selected in Step S5020, the individual model decrypted in Step S5040 or generated in Step S5041, and the common model received in Step S3020 to train the common model and the individual model (S5050). Specifically, for example, the local learning module 1020 defines a loss function for the models, and searches for weights that minimize the loss function to update those models.

The loss function is a function which models a degree of an ideal relationship of the personal data to the common model and the individual model corresponding thereto, and defines as a loss with respect to an ideal relationship. For example, in a case in which the representative vector of the feature vectors generated from the personal data is used as the individual model, the ideal relationship is a state in which the feature vectors generated by inputting entire personal data into the common model are equal to the representative vector.

Thus, when a sum of squares of distances each between each feature vector and the representative vector is employed as the loss function, the local learning module 1020 minimizes this loss function so that the feature vectors approach the representative vector, resulting in formation of the ideal relationship.

Moreover, when a deep learning model such as a convolutional neural network (CNN) or Transformer is used as the common model, the local learning module 1020 applies an optimization method such as stochastic gradient descent to search for the weights of the common model and the individual model that minimize the loss function, to thereby train those models.

The local learning module 1020 may add noise to the personal data at the time of the training of those models and then execute the training. It has been known that the personal data used for the training can be inferred from a learning result obtained in the participating client 1000, and this addition of the noise can make the inference of the personal data difficult.

FIG. 6 is a flowchart for illustrating an example of the model update processing of Step S3140. The model update module 1120 of the learning server 1100 determines whether or not each participating client 1000 which has transmitted the learning result to the learning server 1100 is the legitimate participating client 1000 selected in Step S3110 (S6110).

The client selection module 1110 records, for example, a terminal number or an IP address as information used to identify the participating client 1000 selected in Step S3110, and the model update module 1120 collates the participating client 1000 which has transmitted the learning result to the learning server 1100 in Step S3140 and the above-mentioned identification information to each other, to thereby make the determination of Step S6110.

The model update module 1120 executes processing steps of Step S6120 and subsequent steps for the legitimate participating client 1000 and excludes an illegitimate client 1000 from the target of the model update processing. There has been known attack called “model poisoning attack,” in which the participating client 1000 transmits an illegitimate learning result to reduce the accuracy of the model, and hence the model update module 1120 executes the processing step of Step S6110 in order to prevent this attack.

After that, the model update module 1120 aggregates the common models received from the plurality of participating clients 1000 (S6120). Specifically, for example, the model update module 1120 calculates a weight of a single common model from the weights of the common models trained by the participating clients 1000.

For example, the model update module 1120 uses the federated averaging of calculating an average of the weights of the common models trained by the participating clients 1000 as the weight after the aggregation.

It has been known that the personal data can be inferred from the weight of the common model, and hence it is preferred that the participating client 1000 avoid transmitting the common model in the non-concealed form to the learning server 1100, and the model update module 1120 aggregate those weights of the common models while the weights are concealed. As a method of achieving the aggregation of the weights of the common models while those weights remain concealed, a method called “secure aggregation” is proposed. Through use of this technology together with this embodiment, the averaged weight of the common models can be calculated while the weights of the individual common models are concealed from the learning server 1100.

After that, the model update module 1120 optimizes the individual model received from each participating client 1000 (S6130). For example, when the representative vector corresponding to the feature vectors generated from the personal data is used as the individual model, the concealed representative vectors of the users 210 of the participating clients 1000 are aggregated in the learning server 1100. This representative vector is a vector positioned at the center of the feature vectors output by inputting the personal data on each user 210 to the common model. Thus, when a distance between the representative vectors of certain two users 210 is short, it is difficult to identify those two users 210 through use of the feature vectors, and hence the identification capability decreases. Thus, it is preferred that all distances each between the representative vectors be equal to or longer than a predetermined value.

The model update module 1120 obtains the representative vectors which decrease a loss function representing this feature (for example, obtains gradients of the representative vectors for the loss function, and obtains the representative vectors updated in gradient directions), to thereby be able to optimize the representative vectors. Specifically, for example, a value of a margin between the representative vectors is defined, and when the distance between the representative vectors is shorter than the margin, a square of a distance between the margin and the representative vector is calculated, and a loss function is defined as a sum of the calculated squared distances. When the value of this function is 0, an ideal state in which each of all of the distances between the representative vectors is equal to or longer than the margin is achieved. The loss function is not limited to the loss function which uses the margin and the distance between the representative vectors, and any function such as a Softmax Cross Entropy function which has a smaller output as the distance between the representative vectors increases.

The individual model is transmitted from the participating client 1000 under the state in which the individual model is concealed through use of the parameter, and optimization equivalent to that in the non-concealed state can be achieved even under the concealed state depending on the method for the concealment. For example, when the orthonormal matrix is used as the parameter and the concealment that uses projective transformation is executed, the distance between the representative vectors before the concealment and the distance between the representative vectors after the concealment are equal to each other. Thus, equivalent optimization can be executed.

After that, the model update module 1120 stores the common model obtained by the aggregation in Step S6120 in the common model storage module 1190 (S6140).

FIG. 7 is a flowchart for illustrating an example of the individual model storage processing of Step S3070. The model transformation module 1030 of the participating client 1000 applies the inverse transformation of the concealment transformation to the concealed individual model transmitted by the learning server 1100 in Step S3150, to thereby generate the individual model (S7010).

This inverse transformation is the transformation from the concealed individual model optimized by the learning server 1100 to the optimized individual model, and hence the individual model which can be used for the model training of Step S5050 is obtained through this transformation. For example, when the projective transformation that uses the orthonormal matrix parameter has been used as the concealment transformation, the model transformation module 1030 executes the projective transformation that uses the inverse matrix of the parameter, to thereby be able to obtain the optimized individual model.

After that, the data encryption module 1040 of the participating client 1000 encrypts the individual model obtained through the inverse transformation in Step S7010 (S7020). Specifically, for example, the data encryption module 1040 executes the encryption that uses the secret key, which is any one of the methods described in the encryption processing for the personal data of Step S4030. The model transformation module 1030 stores the individual model encrypted in Step S7020 in the personal data storage module 1090 (S7030).

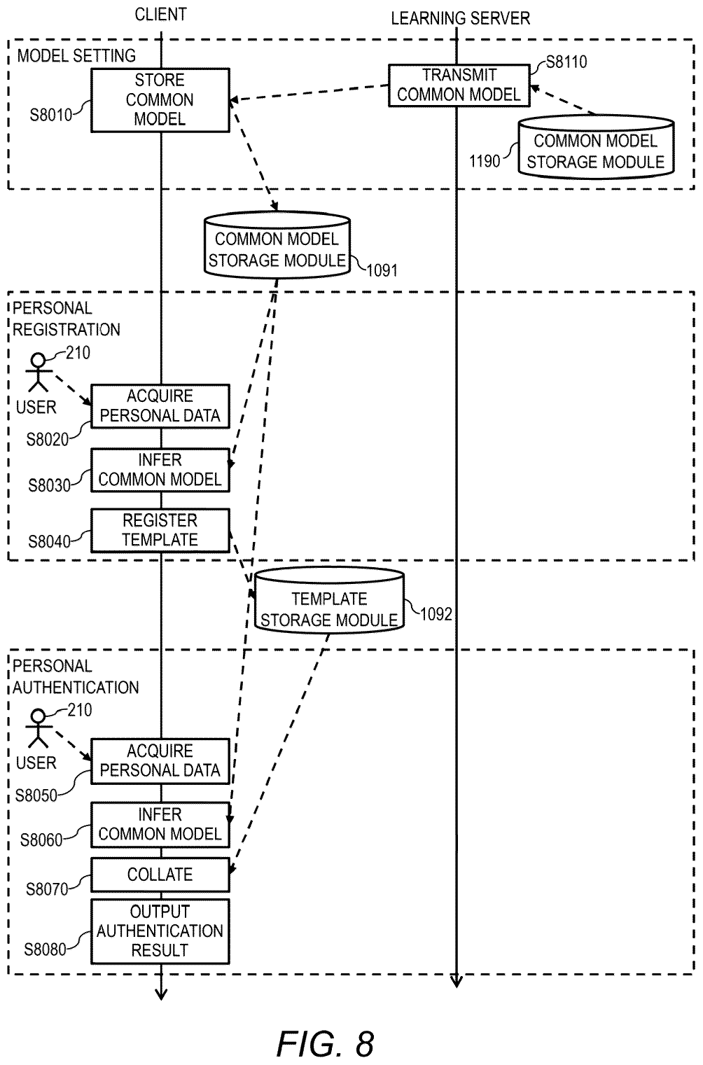

FIG. 8 is a sequence diagram for illustrating an example of the personal authentication processing that uses the common model trained through the procedure of FIG. 3. With reference to FIG. 8, in addition to the personal authentication processing, model setting processing and personal registration processing for the execution of the personal authentication processing are described.

First, as the model setting processing, processing steps of Step S8010 and Step S8110 are executed. The model update module 1120 of the learning server 1100 acquires the common model from the common model storage module 1190, and transmits the common model to the client 1000 (S8110). The local learning module 1020 of the client 1000 receives the common model and stores the common model in the common model storage module 1091 (S8010). It is not required to execute the model setting processing each time the personal authentication is executed, and is executed by a developer or an administrator of an authentication system at a timing at which operation of the authentication system is newly started or at the time of update of a version of the authentication system.

After that, as the personal registration processing, processing steps of Step S8020, Step S8030, and Step S8040 are executed. The personal data acquisition module 1010 of the client 1000 acquires the personal data (for the registration) from the user 210 (S8020), and inputs the acquired personal data to the common model stored in the common model storage module 1091, to thereby generate the feature vector (S8030).

The personal data acquisition module 1010 generates the template for the registration from the generated feature vector, and stores the template in the template storage module 1092 (S8040). The template is information for the registration generated from the personal data. The personal data acquisition module 1010 may treat the feature vector itself as the template. The personal data acquisition module 1010 may apply a predetermined template protection technology when the template is generated, to thereby apply measures for preventing the leakage of the personal data from the template.

Finally, as the personal authentication processing, processing steps of Step S8050, Step S8060, Step S8070, and Step S8080 are executed. The personal data acquisition module 1010 acquires the personal data (for the authentication) from the user 210 (S8050), and inputs the acquired personal data to the common model stored in the common model storage module 1091, to thereby generate the feature vector (S8060).

The authentication result output module 1060 collates the feature vector generated in Step S8060 and the template stored in the template storage module 1092 to each other, and calculates similarity, dissimilarity, or the like as a collation result (S8070).

The authentication result output module 1060 calculates, when the authentication is executed based on a distance between the feature vectors, a Hamming distance or a Euclidian distance between the feature vectors, and treats the calculated distance as the dissimilarity. The authentication result output module 1060 applies thresholding or the like to the collation result, to thereby determine an authentication result indicating authentication success or authentication failure, and outputs the authentication result to, for example, the output device 2050 of the computer forming the client 1000 (S8080).

The collation result is not limited to a continuous value such as the similarity or the dissimilarity, and a binary value indicating the authentication success or the authentication failure may be obtained as the collation result when the template protection technology is used to generate the template. In this case, the authentication result output module 1060 is not required to execute the above-mentioned thresholding, and is only required to output the collation result itself as the authentication result.

As described above, the machine learning system according to the first embodiment can train a highly accurate common model while the privacy of the individual model is protected.

### Second Embodiment

A machine learning system according to a second embodiment of this invention does not execute the concealment transformation processing for the individual model executed in the first embodiment. Moreover, the machine learning system according to the second embodiment fixedly uses the individual model first assigned based on the personal data, that is, does not optimize the personal data. Thus, the machine learning system according to the second embodiment is no longer required to transmit and receive even the individual model subjected to the concealment transformation, and can achieve privacy protection higher than that in the first embodiment.

The machine learning system according to the second embodiment does not update the individual model, and hence the individual models of two clients 1000 different from each other may be similar to each other at the time of the initial assignment. In this case, the common models which output the feature vectors similar to each other to the users of those two clients 1000 different from each other are trained, and hence the accuracy decreases.

Thus, for the machine learning system according to the second embodiment to train a highly accurate common model, it is required to use a weight having a certain degree of the identification capability to initialize the common model. In this case, the individual model does not change, and hence identification capability between individuals cannot be learned. Thus, the accuracy is increased by reducing variation within the individual, to thereby cause all pieces of personal data to approach the individual model.

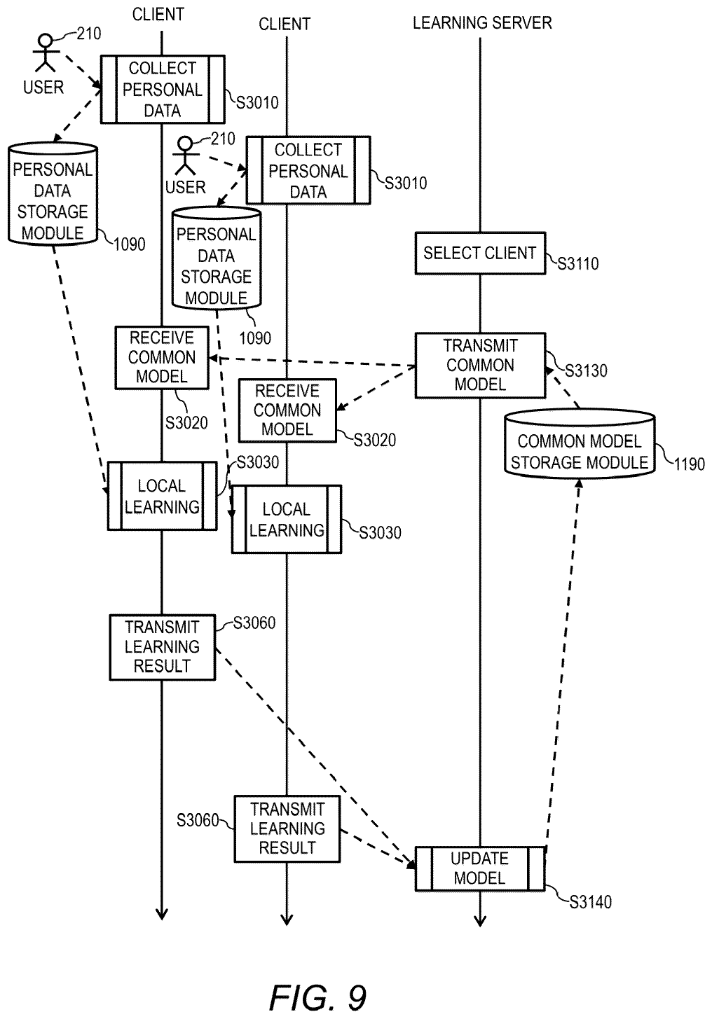

FIG. 9 is a sequence diagram for illustrating an example of the federated learning processing for the personal authentication. Differences of the processing of FIG. 9 from FIG. 3 are described below, and description of the same processing as the processing of FIG. 3 is appropriately omitted.

In the processing of FIG. 9, the parameter used for the concealment processing is not used, and hence the machine learning system according to the second embodiment is not required to include the parameter server 1200. Further, the transmission and reception of the parameter and the transformation that uses the parameter are not required, and hence the processing steps of Step S3120, Step S3040, Step S3050, Step S3150, and Step S3070 are not executed. Further, in the model training processing of Step S5050 included in the local learning processing of Step S3030, the update processing for the individual model is not executed.

In the first embodiment, when a third party other than the user of the client 1000 acquires both the concealed individual model and the parameter with a high-level attack, the third party can acquire the individual model through the inverse transformation.

The third party which has acquired the individual model can execute the impersonation and can infer the personal data, and hence it is required to prevent the leakage of the individual model. Thus, in the first embodiment, it is required to take security measures, to thereby minimize such a risk that the learning server 1100 and the parameter server 1200 are simultaneously attacked and the information consequently leaks.

Meanwhile, in the second embodiment, the information relating to the individual model remains in the client 1000 in the first place, and hence even when the learning server 1100 is attacked, the individual model and the personal data do not leak immediately. As a result, in the second embodiment, federated learning safer than that in the first embodiment can be achieved.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

1. A machine learning system, comprising:
a server configured to hold a common model; and
a plurality of clients each configured to hold concealment target data and an individual model,
wherein the server is configured to transmit the common model to the plurality of clients,
wherein each of the plurality of clients is configured to:
generate a learning result obtained by updating the common model based on the concealment target data and the individual model held by the each of the plurality of clients itself; and
transmit the generated learning result to the server, and
wherein the server is configured to update the common model held by the server itself based on the learning result received from the each of the plurality of clients.

2. The machine learning system according to claim 1,
wherein the each of the plurality of clients is configured to:
generate a concealed individual model by applying concealment transformation to the individual model held by the each of the plurality of clients itself; and
transmit, to the server, the generated concealed individual model in association with identification information for identifying the each of the plurality of clients,
wherein the server is configured to:
update each of the concealed individual models based on the concealed individual models transmitted by the plurality of clients; and
transmit each of the updated concealed individual models to each of the plurality of clients indicated by the identification information corresponding to the concealed individual model, and
wherein the each of the plurality of clients is configured to:
restore an updated individual model from the updated concealed individual model received from the server; and
update the individual model held by the each of the plurality of clients itself.

3. The machine learning system according to claim 2, wherein the concealment transformation includes projective transformation having an orthonormal matrix as a parameter.

4. The machine learning system according to claim 2, further comprising a parameter server configured to hold a parameter,
wherein the parameter server is configured to transmit the parameter to the plurality of clients, and
wherein the each of the plurality of clients is configured to execute the concealment transformation through use of the parameter received from the parameter server.

5. The machine learning system according to claim 1,
wherein the concealment target data is personal data, and
wherein a first client included in the plurality of clients is configured to:
hold:
the common model;
a template based on a feature vector for registration obtained by inputting personal data for registration to the common model; and
personal data for authentication;
input the personal data for authentication to the common model, to thereby acquire a feature vector for authentication; and
execute personal authentication based on the template and the acquired feature vector for authentication.

6. The machine learning system according to claim 1, wherein the individual model held by the each of the plurality of clients is a fixed model exclusively held by the each of the plurality of clients, and is generated based on the common model and personal data held by the each of the plurality of clients.

7. A machine learning method by a machine learning system,
wherein the machine learning system includes:
a server configured to hold a common model; and
a plurality of clients each configured to hold concealment target data and an individual model,
the machine learning method comprising:
transmitting, by the server, the common model to the plurality of clients;
generating, by each of the plurality of clients, a learning result obtained by updating the common model based on the concealment target data and the individual model held by the each of the plurality of clients itself;
transmitting, by the each of the plurality of clients, the generated learning result to the server; and
updating, by the server, the common model held by the server itself based on the learning result received from the each of the plurality of clients.

8. The machine learning method according to claim 7, further comprising:
generating, by the each of the plurality of the clients, a concealed individual model by applying concealment transformation to the individual model held by the each of the plurality of clients itself;
transmitting, by the each of the plurality of the clients, to the server, the generated concealed individual model in association with identification information for identifying the each of the plurality of clients;
updating, by the server, each of the concealed individual models based on the concealed individual models transmitted by the plurality of clients;
transmitting, by the server, each of the updated concealed individual models to the each of the plurality of clients indicated by the identification information corresponding to the concealed individual model;
restoring, by the each of the plurality of clients, an updated individual model from the updated concealed individual model received from the server; and
updating, by the each of the plurality of clients, the individual model held by the each of the plurality of clients itself.

9. The machine learning method according to claim 8, wherein the concealment transformation includes projective transformation having an orthonormal matrix as a parameter.

10. The machine learning method according to claim 8,
wherein the machine learning system includes a parameter server configured to hold a parameter,
the machine learning method further comprising:
transmitting, by the parameter server, the parameter to the plurality of clients; and
executing, by the each of the plurality of clients, the concealment transformation through use of the parameter received from the parameter server.

11. The machine learning method according to claim 7,
wherein the concealment target data is personal data, and
wherein a first client included in the plurality of clients is configured to hold:
the common model;
a template based on a feature vector for registration obtained by inputting personal data for registration to the common model; and
personal data for authentication;
the machine learning method further comprising:
inputting, by the first client, the personal data for authentication to the common model, to thereby acquire a feature vector for authentication; and
executing, by the first client, personal authentication based on the template and the acquired feature vector for authentication.

12. The machine learning method according to claim 7, wherein the individual model held by the each of the plurality of clients is a fixed model exclusively held by the each of the plurality of clients, and is generated based on the common model and personal data held by the each of the plurality of clients.
